(19) United States
(12) Patent Application Publication
(10) Pub. No.: US 2020/0294402 A1
(43) Pub. Date: Sep. 17, 2020

(54) ENHANCED VISUAL SAFETY INDICATORS FOR PARKING SPACES

(71) Applicant: Clyde Morgan, Gardner, KS (US)

(72) Inventor: Clyde Morgan, Gardner, KS (US)

(21) Appl. No.: 16/352,283

(22) Filed: Mar. 13, 2019

(51) Int. Cl. G08G 1/16; E04H 6/42

(52) U.S. Cl. CPC G08G 1/168; B60R 2300/806; E04H 6/426

(57) ABSTRACT

A system of enhanced safety indicators for assisting and/or facilitating parking non-, semi-, or fully-autonomous vehicles. First rear safety indicators are positioned on or projected onto a rear vertical barrier associated with the parking space, and demarcate a rear limit and an associated depth dimension, left and right limits and an associated width dimension, and a center of the parking space. Second upper safety indicators are positioned on or projected onto on an upper surface, and demarcate an upper limit and an associated height dimension, the left and right limits and the associated width dimension, and the center of the parking space. Third center lower safety indicators are positioned on or projected onto a lower surface and demarcate the center of the parking space. The enhanced visual parking space safety indicators may supplement or replace conventional safety surface line markings located on the lower surface of the parking space.

### FIELD

The present invention relates to visual guides for facilitating the positioning of vehicles, and more particularly, embodiments concern enhanced visual safety indicators for more effectively assisting drivers of automobiles and other operators of other vehicles to more properly and safely position their vehicles in parking spaces.

### BACKGROUND

Safety surface line marking is ubiquitously used to demarcate parking spaces and assist drivers in parking their vehicles in those parking spaces. However, safety surface line marking is less or not at all effective for this purpose for drivers who unable to see the lines while parking their vehicles. There are many reasons why some drivers experience this problem, including the size of the driver, the size and/or design of the vehicle, the limited mobility or other physical imparity of the driver, the position of the lines, fading of the lines from wear, poor lighting, and the inexperience of the driver who is unable to judge distance or gauge the locations of the lines without actually seeing them.

All vehicles have side mirrors which can assist their drivers when backing into parking spaces, but which would have to be repositioned downwardly for parking and then returned to their original positions for driving, and are therefore inconvenient to use and of little practical value for this purpose. Further, while some vehicles have cameras that can display relevant information to assist their drivers when backing into parking spaces, such technology is present only on relatively expensive vehicles, or may be malfunctioning, and is therefore not generally available or not always reliable when it is available.

As a result, it is not uncommon for drivers to fail to properly center their vehicles in parking spaces. This may be particularly problematic for larger sport utility vehicles and trucks that have smaller margins within standard parking spaces. Reports by the insurance industry indicate that this often results in damage to both the incorrectly parked vehicles, adjacent correctly parked vehicles, and adjacent structures. This issue has been neglected by designers, owners, and operators of both private and commercial parking lots and garages, who have failed to address relevant insurance and law enforcement statistical findings. Similar problems exist for operators of other vehicles.

This background discussion is intended to provide information related to the present invention which is not necessarily prior art.

SUMMARY

Embodiments of the present invention solve the above-described and other problems and limitations by providing enhanced visual safety indicators for more effectively assisting drivers of cars and trucks and other operators of other vehicles (e.g., recreational vehicles, tractor-trailers, trailers of various kinds, boats and other watercraft, aircraft) to more properly and safely position their vehicles in parking spaces.

In a first embodiment of the present invention, a system is provided for visually defining a parking space to enhance an ability of an operator of a vehicle to park the vehicle in the parking space. This system may comprise one or more rear safety indicators positioned on a vertical barrier located at a rear limit of the parking space. In a second embodiment of the present invention, a system is provided for visually defining a parking space to enhance an ability of an operator of a vehicle to park the vehicle in the parking space. This system may comprise one or more upper safety indicators positioned on an upper barrier located at an upper limit of the parking space. In a third embodiment of the present invention, a system is provided for visually defining a parking space to facilitate the parking of a vehicle in the parking space. This system may comprise one or more center lower safety indicators positioned on a lower surface at an approximate center of the parking space. Aspects of the first, second, and/or third embodiments may be combined to provide all of one or more rear, upper, and/or center lower safety indicators.

Various implementations of the foregoing embodiments may include any one or more of the following additional features. The vehicle may be a car, truck, recreational vehicle, tractor-trailer, trailer of any variety (e.g., camper, cargo, motorcycle, horse, boat), watercraft, or aircraft, or a hybrid vehicle that is a combination of any thereof. The safety indicators may have a form such as a rectangle, circle, symbol, letter, number, or word, or a combination of any thereof. The safety indicators may be constructed of a material such as an adhesive tape, paint, engraving, architectural element, reflective material, artificially illuminated device (whether visible light or non-visible light for assisted-driving or self-driving vehicles), laser generator, or sound generating device (whether audible or non-audible sound for assisted driving or self-driving vehicles), or a combination of any thereof.

The rear safety indicators may demarcate a rear limit, a left limit and a right limit, and/or a center of the parking space. Relatedly, the rear safety indicators may include a left rear safety indicator which demarcates the left limit of the parking space, and a right rear safety indicator which demarcates the right limit of the parking space, wherein the left rear safety indicator and the right rear safety indicator cooperate to demarcate the width dimension of the parking space. The rear safety indicators may extend continuously or severally from a lower height to an upper height on the vertical barrier.

The upper safety indicators may demarcate an upper limit, a left limit and a right limit, and/or a center of the parking space. Relatedly, the upper safety indicators may include a left upper safety indicator which demarcates a left limit of the parking space, and a right upper safety indicator which demarcates a right limit of the parking space, wherein the left upper safety indicator and the right upper safety indicator cooperate to demarcate a width dimension of the parking space. The upper safety indicators may extend continuously or severally from a rearward position to a forward position on the horizontal upper barrier.

The vehicle may be a non-autonomous vehicle controlled by a driver or an at least semi-autonomous (i.e., semi- or fully-autonomous) vehicle. The center lower safety indicators may be four inches wide, or between one-eighth inch and six inches wide. The center lower safety indicators may be projected onto the lower surface of the parking space by a laser projector in response to a signal from a remote control device such as a garage door opener. The center lower safety indicators may be detectable by a sensor of the semi- or fully-autonomous vehicle. The center lower safety indicators may include an electromagnetic emitter which produces an electromagnetic signal which is detectable by the sensor of the semi- or fully-autonomous vehicle. The center lower safety indicators may include a rear stop element configured to communicate a stopping point for the semi- or fully-autonomous vehicle in the parking space.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1A (PRIOR ART) is a front perspective view of a parking space having only conventional safety surface line markings, and with the boundaries of the parking space shown in broken line;

FIG. 1B (PRIOR ART) is a plan view of parking spaces having only conventional safety surface line markings;

FIG. 2 is a fragmentary elevation view of a first implementation of a first embodiment of a system of enhanced visual safety indicators for more effectively assisting an operator of a vehicle to more properly and safely position their vehicle in a parking space;

FIG. 3 is a fragmentary elevation view of a second implementation of the first embodiment of the system of enhanced visual safety indicators;

FIG. 4 is a fragmentary elevation view of a first implementation of a second embodiment of the system of enhanced visual safety indicators;

FIG. 5 is a fragmentary elevation view of a second implementation of the second embodiment of the system of enhanced visual safety indicators;

FIG. 6 is a fragmentary elevation view of the system of enhanced visual safety indicators combining features of the implementations of FIGS. 2 and 4;

FIG. 7 is a fragmentary elevation view of the system of enhanced visual safety indicators combining features of the implementations of FIGS. 3 and 5;

FIG. 8 is a fragmentary elevation view of a first implementation of a third embodiment of the system of enhanced visual safety indicators, wherein the indicators are center lower safety indicators;

FIG. 9 is a plan view of a parking space employing the center lower safety indicators, wherein the indicators are shown as a plurality of spaced-apart markings;

FIG. 10 is a perspective view through a rear camera of the parking space employing the center lower safety indicators, where the indicators are shown as a single elongated marking;

FIG. 11 is a front elevation view of a parking space employing the center lower safety indicators, wherein the indicators are projected onto a lower surface of the parking space by a projector; and

FIG. 12 is a plan view of the parking space of FIG. 11.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment”, “an embodiment”, or “embodiments” mean that the feature or features referred to are included in at least one embodiment of the invention. Separate references to “one embodiment”, “an embodiment”, or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular implementations of the present invention can include a variety of combinations and/or integrations of the embodiments described herein.

Broadly characterized, the present invention provides improved visual guides for facilitating the positioning of vehicles. More particularly, embodiments provide enhanced visual safety indicators for more effectively assisting drivers of cars and trucks and other operators of other vehicles (e.g., recreational vehicles, tractor-trailers, trailers of various kinds (e.g., camper, cargo, motorcycle, horse, boat), boats and other watercraft, aircraft) to more properly and safely position their vehicles in parking spaces. Embodiments may facilitate both entering and exiting parking spaces, and may be employed in substantially any suitable location such as in public parking areas, private parking areas, garage parking areas, pathways, docks, and hangars, and particularly in any such location (e.g., hospitals, assisted living facilities, rehabilitation facilities, and/or in handicapped parking spaces anywhere) in which the elderly, disabled, or other persons with relevant physical limitations may need or desire to park their vehicles. The safety indicators advantageously enhance personal and property safety especially with regard to locating the center of a parking space and/or providing an aid in determining distance between a vehicle and a barrier such as curb, wall, fence, post, cable, sign, or other obstacle located proximate to the parking space.

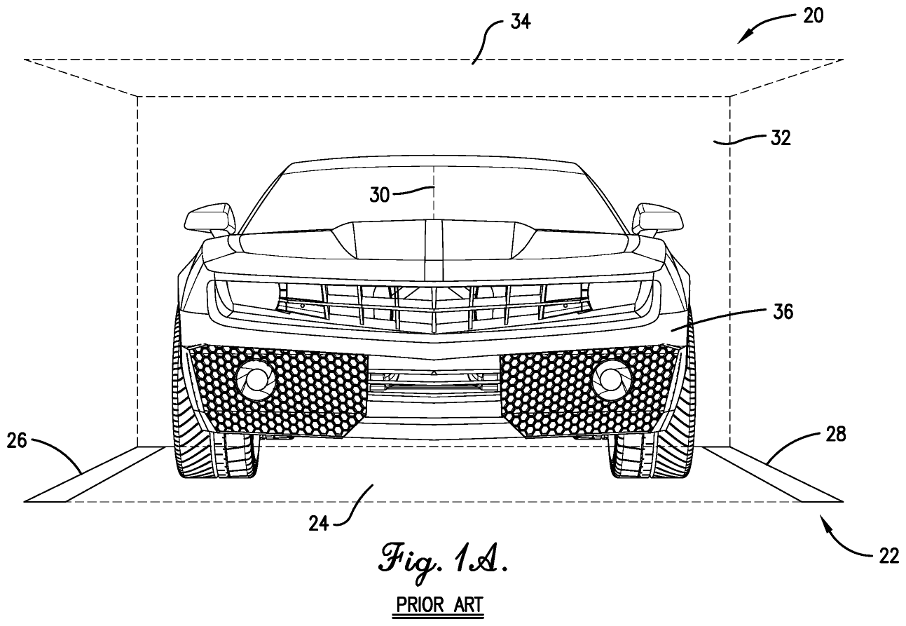

Referring to FIGS. 1A and 1B (PRIOR ART), a parking space 20 is shown having only conventional safety surface line markings 22, and with the boundaries of the parking space shown in broken line. In particular, the parking space 20 may have a lower surface 24, a left (or port) limit 26, a right (or starboard) limit 28, a center 30 located between the left and right limits 26,28, a rear limit 32, and an upper limit 34. As used herein, the “rear” limit 32 is defined as the opposite end of the parking space 20 from where the vehicle ordinarily enters and leaves the parking space 20, regardless of whether the vehicle enters the parking space with a forward or backward orientation. To be clear, if the entrance of the parking space 20 is considered an “open” end for receiving the vehicle, then the rear limit 32 may be considered a “closed” end. Only the left and right limits 26,28 may be indicated by the conventional line markings 22 applied to the lower surface 24 to the parking space 20, and these may be difficult or impossible to see for a driver of a vehicle 36 for a variety of different reasons. In various additive or alternative implementations, the visual safety indicators of the present invention may be located vertically and/or horizontally, behind and/or above the parking space 20, and/or to the sides of and/or centered on the parking space 20 so as to replace or supplement the conventional line markings 22 with more clearly visible and effective guides for the driver to more successfully park the vehicle 36 near or in the optimal center 30 of the space 20, whether maneuvering the vehicle 36 forwardly or backwardly into the space 20.

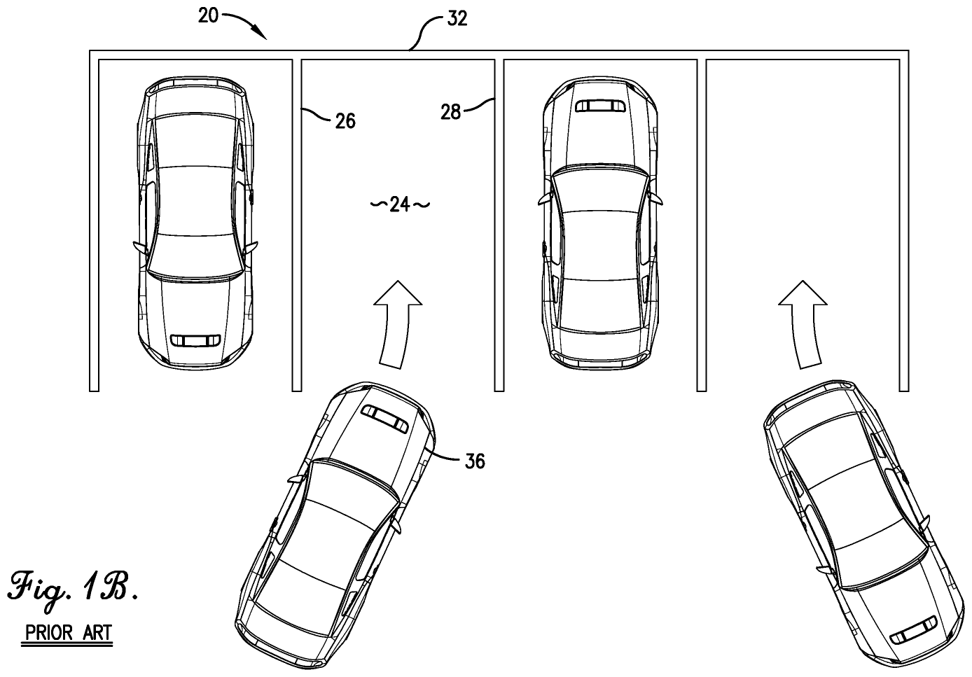

In more detail, referring to FIGS. 2-7, embodiments of a system of enhanced visual safety indicators 40 are shown in an exemplary operating environment for more effectively assisting an operator of a vehicle 36 to more properly and safely park the vehicle 36 in the parking space 20. Broadly, the system may include one or more of the visual parking space safety indicators 40 which may replace or supplement the two conventional line markings 22 located on the surface 24 of the parking space 20.

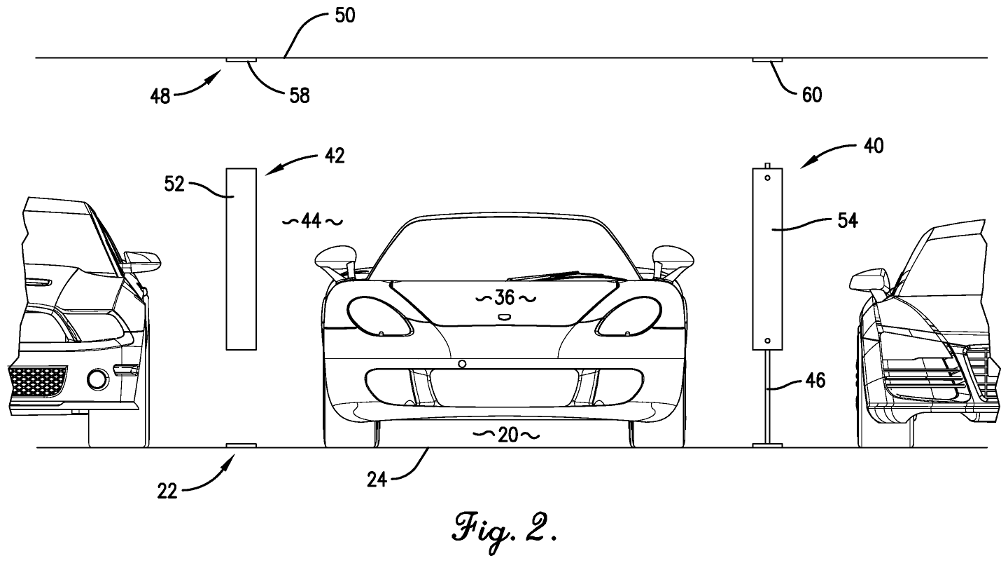

The safety indicators 40 may take substantially any suitable form or combinations of forms, such as rectangular (as seen in FIGS. 2, 4, and 6), round (as seen in FIGS. 3, 5, and 7), symbolic (e.g., arrows), and/or alphanumeric (e.g., letters, numbers, and/or words), and combinations thereof. The safety indicators 40 may be constructed of substantially any suitable material or design or combination of materials or designs, such as adhesive tapes, paints, engravings, architectural elements, reflective materials, artificially illuminated devices (whether visible light or non-visible light for assisted-driving or self-driving vehicles), laser generators, or sound generating devices (whether audible or non-audible sound for assisted driving or self-driving vehicles), or a combination of any thereof.

The safety indicators 40 may extend from a lower or first height or position to an upper or second height or position in order to ensure visibility for difference sized drivers in different sized vehicles. More generally, the safety indicators 40 may be adapted for use with substantially any suitable vehicle, such as automobiles (e.g., cars, sport utility vehicles, trucks, vans), recreational vehicles, tractor-trailers, trailers of various kinds (e.g., camper, cargo, motorcycle, horse, boat), watercraft (in which case the parking space may be at a dock), and/or aircraft (in which case the parking space 20 may be in a hanger), and/or hybrid vehicles which are combinations thereof. Further, in addition to being more visible to unassisted drivers, one or more of the safety indicators 40 may be positioned so as to be visible by vehicle cameras and/or normally positioned vehicle side and/or rearview mirrors.

The visual parking space safety indicators 40 may include one or more first rear safety indicators 42 which may be mounted on a vertical barrier (e.g., a curb or wall 44 or structure 46 (such as a post or cable, whether singular or part of, e.g., a fence)) located at or near the rear limit 32 of the parking space 20, and/or one or more second upper safety indicators 48 which may be positioned on a horizontal upper barrier (e.g., a ceiling 50 or structure (such as the aforementioned post or cable)) located at or near the upper limit 34 of the parking space 20.

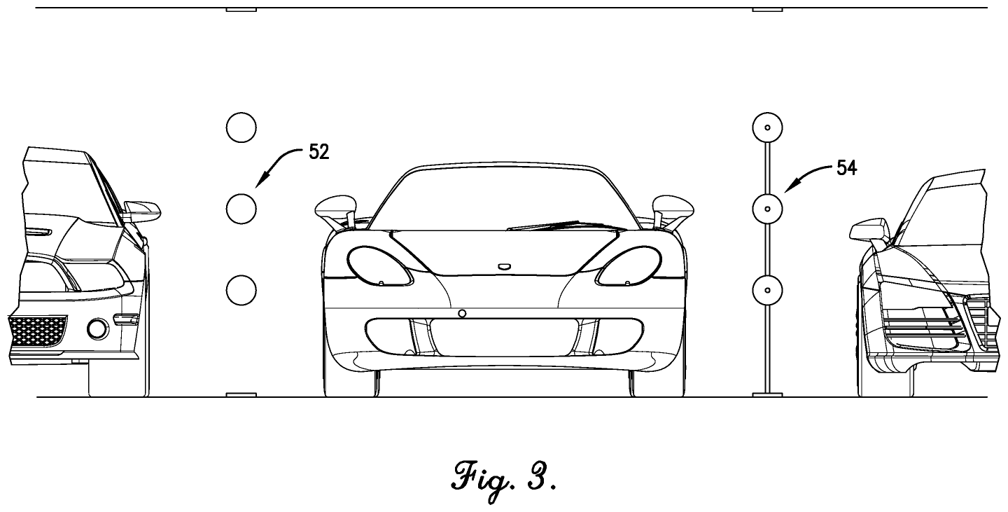

The first rear safety indicators 42 may extend continuously (as seen in FIGS. 2, 4, and 6) or severally (and seen in FIGS. 3, 5, and 7) from a lower height to an upper height on the vertical barrier 44,46, thereby maximizing their visibility to operators of different seizes and abilities in vehicles of different sizes and designs. The first rear safety indicators 42 may demarcate the rear limit 32 of the parking space 20. Additionally or alternatively, the first rear safety indicators 42 may demarcate the left and right limits 26,28 of the parking space 20. For example, the first rear safety indicators 42 may include a left rear safety indicator 52 which demarcates the left limit 26 of the parking space 20, and a right rear safety indicator 54 which demarcates the right limit 28 of the parking space 20, such that the left and right rear safety indicators 52,54 cooperate to demarcate a width dimension of the parking space 20. Additionally or alternatively, the first rear safety indicators 42 may include a center rear safety indicator 56 (seen in FIGS. 4-7) positioned on the vertical barrier 44,46, which demarcates the center 30 of the parking space 20.

The second upper safety indicators 48 may extend continuously (as seen in FIGS. 2, 4, and 6) or severally (and seen in FIGS. 3, 5, and 7) from a rearward position to a forward position on the upper horizontal barrier 50, thereby maximizing their visibility to operators of different seizes and abilities in vehicles of different sizes and designs. The second upper safety indicators 28 may demarcate the upper limit 34 of the parking space 20. Additionally or alternatively, the second upper safety indicators 48 may demarcate the left and right limits 26,28 of the parking space 20. For example, the second upper safety indicators 48 may include a left upper safety indicator 58 which demarcates the left limit 26 of the parking space 20, and a right upper safety indicator 60 which demarcates the right limit 28 of the parking space 20, such that the left and right upper safety indicators 58,60 cooperate to demarcate the width dimension of the parking space 20. Additionally or alternatively, the second upper safety indicators 48 may include a center upper safety indicator 62 (seen in FIGS. 4-7) positioned on the horizontal upper barrier 50, which demarcates the center 30 of the parking space 20.

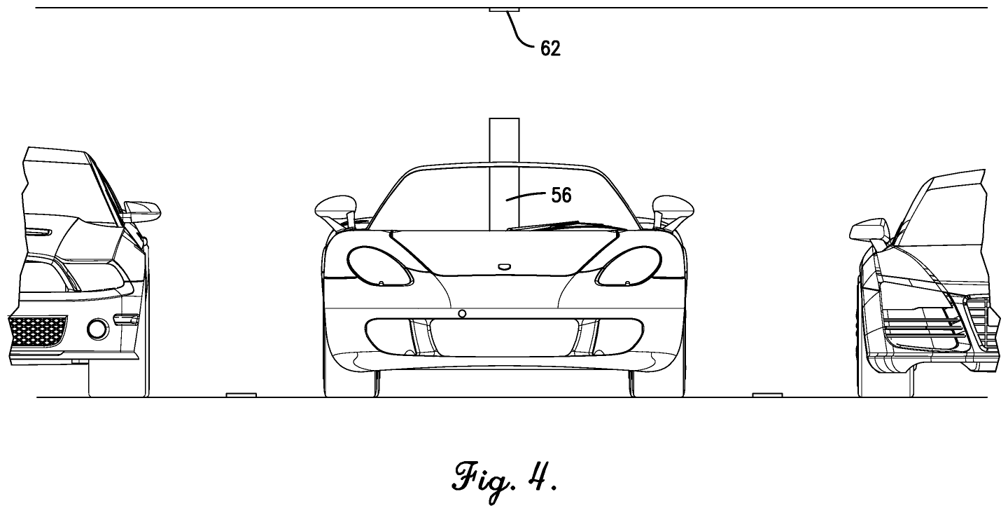

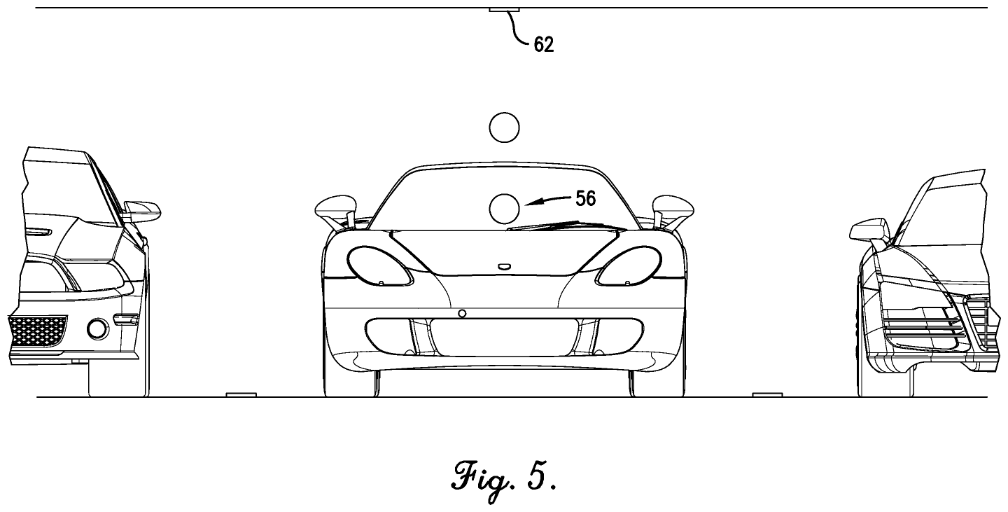

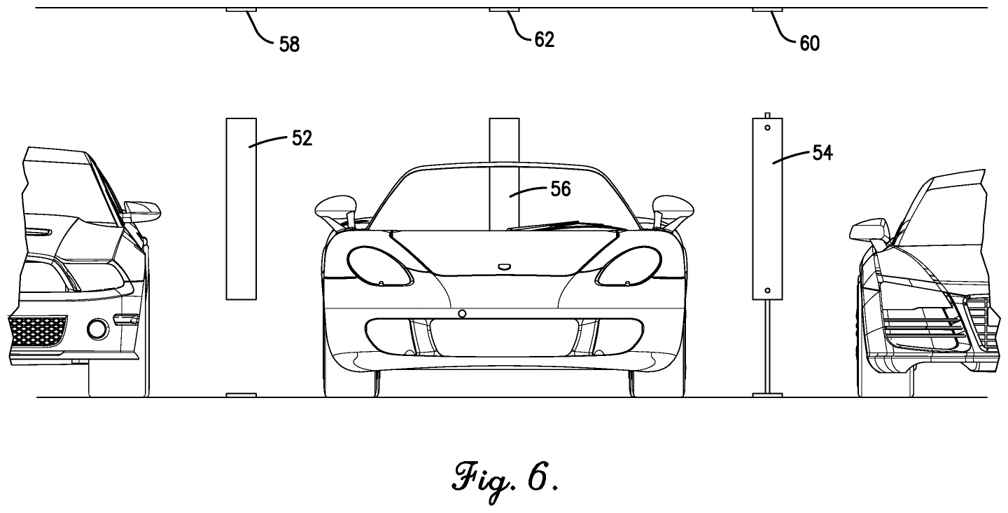

Some or all aspects of the first implementation of the first embodiment seen in FIG. 2, which includes the continuous rectangular left and right rear safety indicators 52,54, and the first implementation of the second embodiment, which includes the continuous rectangular center rear safety indicator 56, seen in FIG. 4, may be incorporated into a single system, such as is shown in FIG. 6. Similarly, some or all aspects of the second implementation of the first embodiment seen in FIG. 3, which includes the several round left and right upper safety indicators 52,54, and the second implementation of the second embodiment, which includes the several round center upper safety indicator 56, seen in FIG. 5, may be incorporated into a single system, such as is shown in FIG. 7. Other combinations of these implementations and embodiments are similarly possible.

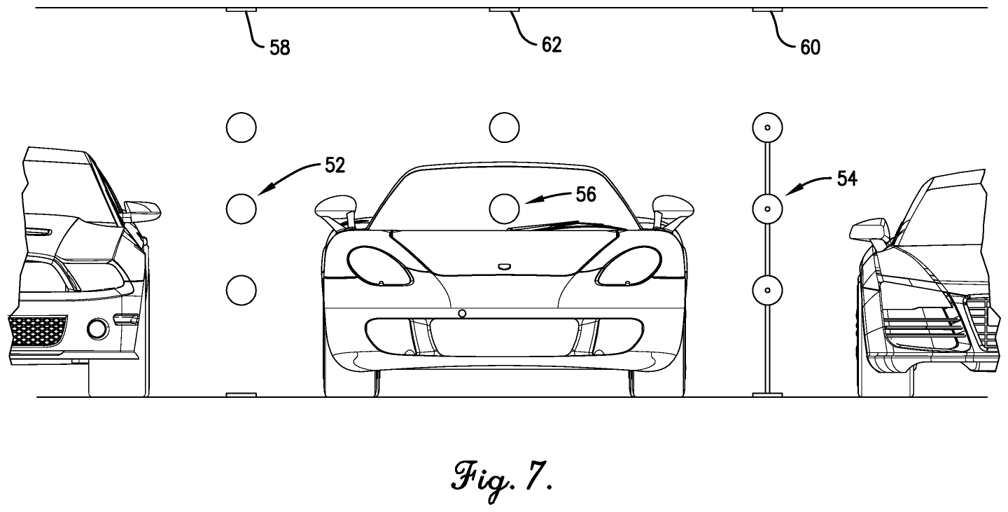

Referring also to FIGS. 8-12, a third embodiment of the enhanced visual safety indicators 40 is shown in an exemplary operating environment for more effectively assisting an operator of the vehicle 36, including large vehicles such as trucks and vans with limited visibility, or for more effectively enabling an at least semi-autonomous (i.e., semi- or fully-autonomous) vehicle 36 to more properly and safely park the vehicle 36 in the parking space 20. In general, aspects of the third embodiment may be substantially similar or identical to corresponding aspects of the first and/or second embodiments, except as follows.

In this third embodiment, the visual parking space safety indicators 40 may include one or more center lower safety indicators 66 which may be mounted on and substantially flush with or raised above, temporarily projected onto, embedded in, or otherwise associated with the lower surface 24 at the approximate center 30 of the parking space 20, i.e., approximately within five percent of being centered or approximately within ten percent of being centered between the left and right limits 26,28 (which may or may not be indicated by conventional markings 22). In various implementations, the one or more center lower safety indicators 66 may replace or supplement the conventional markings 22 and/or the rear and/or upper enhanced markings 42,48.

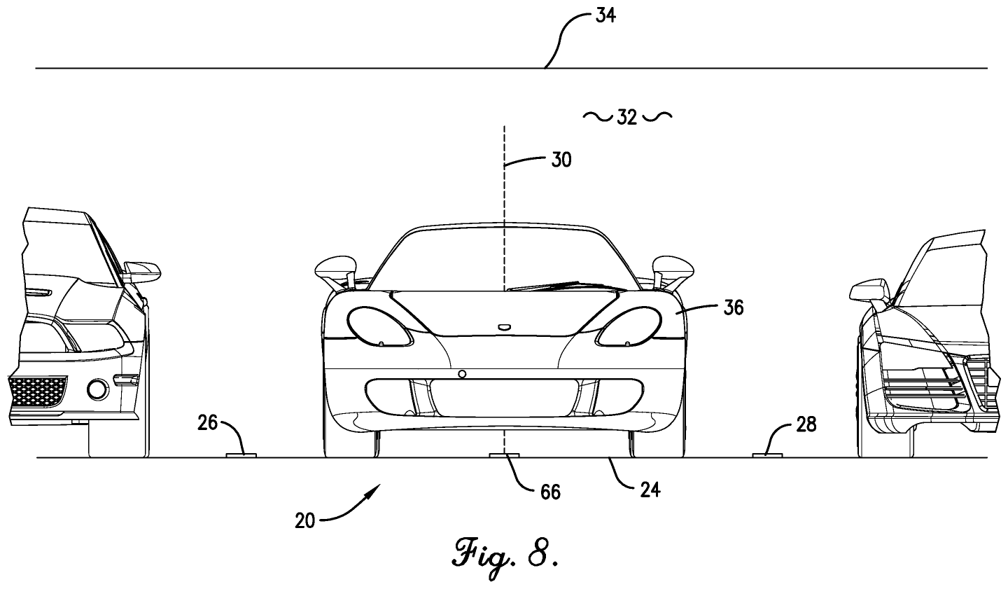

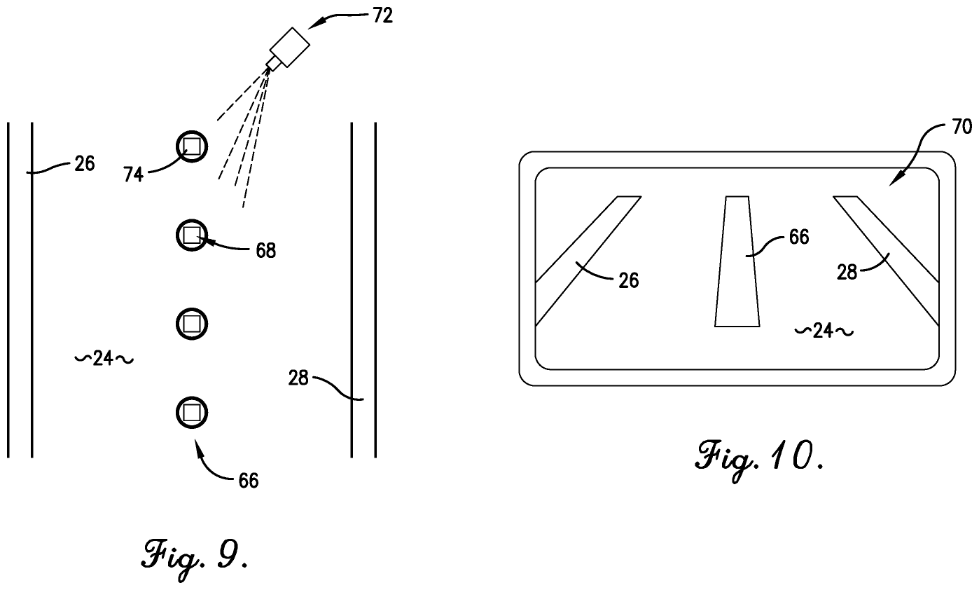

The center lower safety indicators 66 may extend severally (as, e.g., a plurality of circles or other shapes, as seen in FIG. 9) or continuously (as, e.g., an elongated rectangle, as seen in FIG. 10) from a rearward position to a forward position on the lower surface 24, thereby maximizing their visibility to operators of different seizes and abilities in vehicles of different sizes and designs. In various implementations, the center lower safety indicators 66 may be provided along a portion or an entire length of the approximate center 30 of the parking space. In various implementations, the center lower safety indicators 66 may be approximately four inches wide, or approximately between one-eighth inch and six inches wide, or approximately between one-eighth inch and sixteen inches wide.

In various implementations, the one or more center lower safety indicators 66 may be visual in nature (i.e., they can be seen by a driver of the vehicle 36); reflective, electronic, or otherwise detectable in nature (i.e., they can be detected by a sensor of the vehicle 36); or a combination thereof. In particular, the one or more center lower safety indicators 66 may be configured to be conspicuously visible in the displayed view 70 provided by a rearward, or “back-up,” camera of the vehicle 36 to better assist the driver when backing into the parking space 20, as depicted in FIG. 10. Visually perceptible center lower safety indicators 66 may be provided with substantially any desirable coloration, such as yellow, orange, green, or in the case of private garages, an aesthetically matching, complementary, or otherwise desirable color. In one implementation, for public parking spaces the center lower safety indicators 66 may be provided with a color that is both different from the color of the conventional markings 22 to avoid confusion and that is not normally associated with construction or maintenance work or other closure (e.g., not yellow or orange) also to avoid confusion.

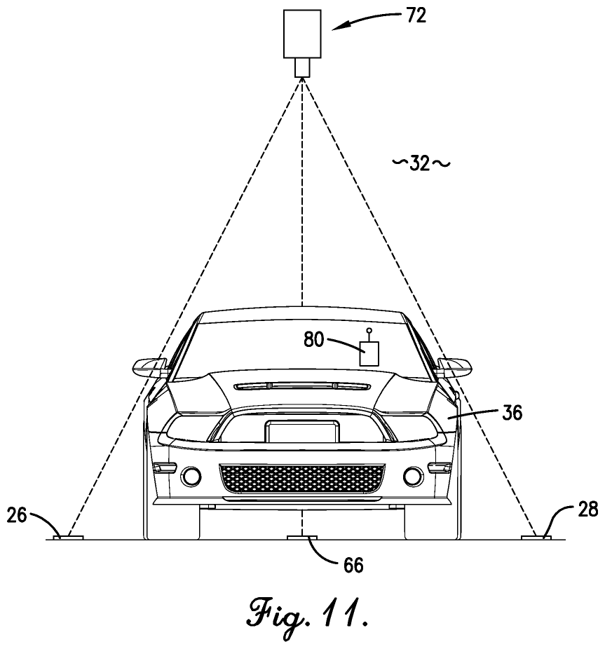

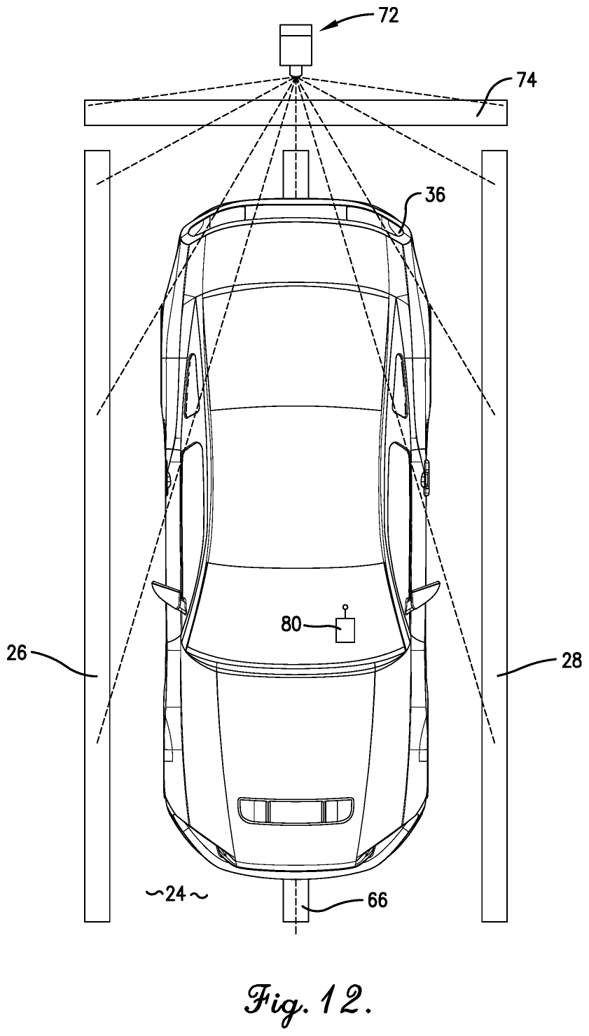

In one implementation, shown in FIGS. 11 and 12, the one or more center lower safety indicators 66 may be temporarily projected onto the lower surface 24 of the parking space 20 as needed. For example, a laser or other projector 72 may be mounted to the upper and/or rear surfaces 32,34 and configured to project the center lower safety indicators 66 onto the lower surface 24 when the vehicle 36 begins the parking maneuver. In one implementation, in which the laser projector 72 is mounted in a residential garage, the laser projector 72 may activate and project the center lower safety indicators 66 when a door of the residential garage is opened to receive the vehicle 36, such as in response to the use of a remote control device 80 which may be a garage door opener or a dedicated remote control device. In one implementation, the laser projector 72 may additionally project the conventional markings 22 and/or the rear and/or upper enhanced markings 42,48.

Additionally or alternatively, the one or more center lower safety indicators 66 may comprise or consist of one or more passive reflectors or active emitters 68 (of, e.g., visible or non-visible light or radio-frequency signals) which can be detected by one or more sensors on the vehicle 36 to accomplish (in the case of semi- or fully-autonomous vehicles) or assist in (in the case of non-autonomous vehicles) parking the vehicle 36, whether in a forward or reverse orientation. For example, the vehicle may be equipped with a visible or infrared light source which emits a light signal which is reflected by one or more reflectors 68 which are part of the indicators 66. In another example, the vehicle may be equipped with a radio-frequency or other electromagnetic signal detector which senses a radio-frequency or other electromagnetic signal emitted or otherwise produced by one or more radio-frequency signal emitters or other electromagnetic signal producers 68 which are part of the indicators 66. In one implementation, detectable center lower safety indicators 66 may include a rear stop element 74 physically or functionally configured to communicate a stopping point for the vehicle 36.

Thus, embodiments of the present invention provide substantial advantages for more clearly and effectively assisting operators to more properly and safely park their vehicles in parking spaces, including providing a practical and cost-effective solution for reducing damage to vehicles and structures resulting from poorly parked vehicles.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A system for visually defining a parking space to facilitate the parking of a vehicle in the parking space, the system comprising one or more center lower safety indicators positioned on a lower surface at an approximate center of the parking space.

2. The system of claim 1, wherein the vehicle is a non-autonomous vehicle controlled by a driver, and the one or more center lower safety indicators enhance an ability of the driver to park the non-autonomous vehicle in the parking space.

3. The system of claim 2, wherein the one or more center lower safety indicators include a form that is selected from the group consisting of: rectangles, circles, symbols, letters, numbers, and words, and combinations thereof.

4. The system of claim 3, wherein the one or more center lower safety indicators are four inches wide.

5. The system of claim 3, wherein the one or more center lower safety indicators are between one-eighth inch and six inches wide.

6. The system of claim 2, wherein the one or more center lower safety indicators are constructed of a material that is selected from the group consisting of: adhesive tapes, paints, engravings, architectural elements, reflective materials, artificially illuminated devices, sound generating devices, and combinations thereof.

7. The system of claim 1, wherein the one or more center lower safety indicators are projected onto the lower surface of the parking space.

8. The system of claim 7, wherein the one or more center lower safety indicators are projected by a laser projector onto the lower surface of the parking space when the vehicle begins parking.

9. The system of claim 8, wherein the laser projector projects the one or more center lower safety indicators in response to a signal from a remote control device.

10. The system of claim 9, wherein the remote control device is a garage door opener.

11. The system of claim 1, wherein the vehicle is an at least semi-autonomous vehicle, and the one or more center lower safety indicators enhance an ability of the at least semi-autonomous vehicle to park itself in the parking space.

12. The system of claim 11, wherein the one or more center lower safety indicators are detectable by a sensor of the at least semi-autonomous vehicle.

13. The system of claim 11, wherein the one or more center lower safety indicators include an electromagnetic emitter which produces an electromagnetic signal which is detectable by the sensor of the at least semi-autonomous vehicle.

14. The system of claim 11, wherein the one or more center lower safety indicators include a rear stop element configured to communicate a stopping point for the at least semi-autonomous vehicle in the parking space.

15. A system for visually defining a parking space to facilitate the parking of a non-autonomous vehicle in the parking space, the system comprising one or more center lower safety indicators positioned on a lower surface at an approximate center of the parking space, wherein the one or more center lower safety indicators are between one-eighth inch and six inches wide.

16. The system of claim 15, wherein—
the one or more center lower safety indicators include a form that is selected from the group consisting of: rectangles, circles, symbols, letters, numbers, and words, and combinations thereof; and
the one or more center lower safety indicators are constructed of a material that is selected from the group consisting of: adhesive tapes, paints, engravings, architectural elements, reflective materials, artificially illuminated devices, sound generating devices, and combinations thereof.

17. The system of claim 15, wherein the one or more center lower safety indicators are projected by a laser projector onto the lower surface of the parking space in response to a signal from a remote control device.

18. A system for visually defining a parking space to facilitate the parking of an at least semi-autonomous vehicle in the parking space, the system comprising one or more center lower safety indicators positioned on a lower surface at an approximate center of the parking space, wherein the one or more center lower safety indicators are detectable by a sensor of the at least semi-autonomous vehicle.

19. The system of claim 18, wherein the one or more safety indicators include an electromagnetic emitter which produces an electromagnetic signal which is detectable by the sensor of the at least semi-autonomous vehicle.

20. The system of claim 18, wherein the one or more center lower safety indicators include a rear stop element configured to communicate a stopping point for the at least semi-autonomous vehicle in the parking space.
